(19) United States
(12) Patent Application Publication
(10) Pub. No.: US 2005/0125443 A1
(43) Pub. Date: Jun. 9, 2005

(54) Automated interpretation of codes

(76) Inventor: Biplav Srivastava, Noida (IN)

Correspondence Address: Frederick W. Gibb, III;McGinn & Gibb, PLLC, Suite 304, 2568-A Riva Road, Annapolis, MD, 21401, US

(21) Appl. No.: 10/729,813

(22) Filed: Dec. 5, 2003

(51) Int. Cl. G06F 17/00

(52) U.S. Cl. 707/103 Y

(57) ABSTRACT

Codes, such as legal or other codified provisions are represented as rules forming logical expressions in a particular rules system. Conversion of these codified provisions to rules can be achieved manually, or partly or wholly through suitable automation. The interests of different parties affected by or having an interest in the codified provisions is represented by evaluation functions forming logical conditions that relate to the party's utility. For events that relate to the codified provisions, such as possible or actual violations of the codified provisions, the rules are evaluated in view of the event using the evaluation functions, and each of the party's evaluation expressions.

### FIELD OF THE INVENTION

The present invention relates to interpreting codes, such as legal or other codified provisions.

### BACKGROUND

The term code, and codified provisions, is used herein to refer to any set of formalized statements of conduct of individuals or legal entities, such as corporations. Such codes may be laws, such as those of civil or criminal justice, international laws, policy statements, contract provisions, agreements, regulations, rules of association, constitutions, codes of conduct, and so on.

Different parties are affected differently by the way in which codes are framed, or used in the context of debate, arbitration, and so on. Such parties are typically interested in what provisions of the code (for example, sections of the law) are applicable to the different parties.

Information technologies are currently used to store and access codes in their many manifestations. Many organisations store laws in databases, and provide a query interface to search or browse the stored legal provisions. Such searches are typically based upon keywords, and are not tailored to an individual user's needs. As an example, the results of a given search are the same irrespective of whether the user is a lawmaker, citizen or policy adviser. Interpretation and analysis of codes is essentially left to human reason alone.

A need exists for an improved manner of using codes in view of these and other observations.

### SUMMARY

Codes, such as legal or other codified provisions are represented as logical expressions in a particular rules system. Conversion of the codified provisions to a suitable rules system can be achieved manually, or through suitable automation. The interests of different parties affected by or having an interest in the codified provisions is represented by logical conditions or evaluation expressions that relate to the party's utility. For events that relate to the codified provisions, such as possible or actual violations of the code, the rules are evaluated in view of the event, and each of the party's evaluation expressions.

The logical structure of a code is used to provide a more meaningful manner of using the code. Automatically identifying applicable provisions of a code can be achieved with reference to an individual stakeholder's perspective. At a macro level, national legislatures and legal policy groups can use techniques described herein to analyse the impact of new policing initiatives in their legal system, or detect existing loopholes. At a micro level, such techniques can assist in performing activities such as analyzing the terms of agreement of a software package before agreeing to such terms by proceeding with its installation.

### DESCRIPTION OF DRAWINGS

FIG. 1 is a schematic representation of the architecture and operation of a system for interpreting codes as described herein.

FIG. 2 is a flow chart of the steps involved in interpreting legal codes as described herein.

FIG. 3 is a schematic representation of a computer system suitable for performing the techniques described herein.

### DETAILED DESCRIPTION

The automated interpretation of code is described in further detail, and specific examples are described relating to the interpretation of a legal code, and a corporate travel policy.

Not all parties who are stakeholders in a code are equally conversant with all aspects of its detailed provisions. But such parties are often expected to take timely actions based on a good understanding of the provisions. As an example, when an apparent crime occurs, police officers are obliged to file an initial report, which is used as the basis for further investigation. Errors in procedure may be used by the legal defence team for the accused to exempt the accused from prosecution.

Different stakeholders can be assisted in interpreting the provisions of a code with respect to those stakeholder's utility perspective. In the above example of a criminal prosecution based upon a legal code, such stakeholders and their respective utility perspectives may be, for example, as outlined below.
(i) Police—not making technical mistakes in legal procedure
(ii) Prosecutor—preparing the prosecution case for successful prosecution
(iii) Defense—preparing defence case for acquittal, or minimum sentencing
(iv) Lawmakers—detecting loopholes

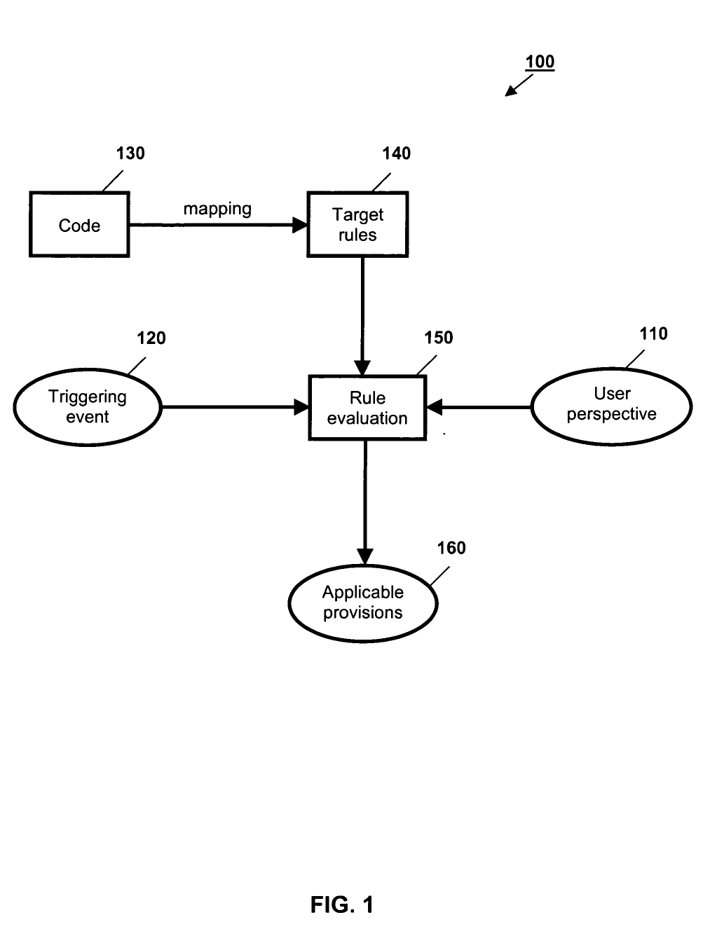

FIG. 1 schematically represents a general system architecture 110 for interpreting codes. Code 130 is mapped to target rules 140, the output of which is provided as input to a rule evaluation engine 150. The rule evaluation engine 150 also has as inputs a user perspective 110, and a triggering event 120. The rule evaluation engine 150 provides as output applicable provisions 160 of the code 130.

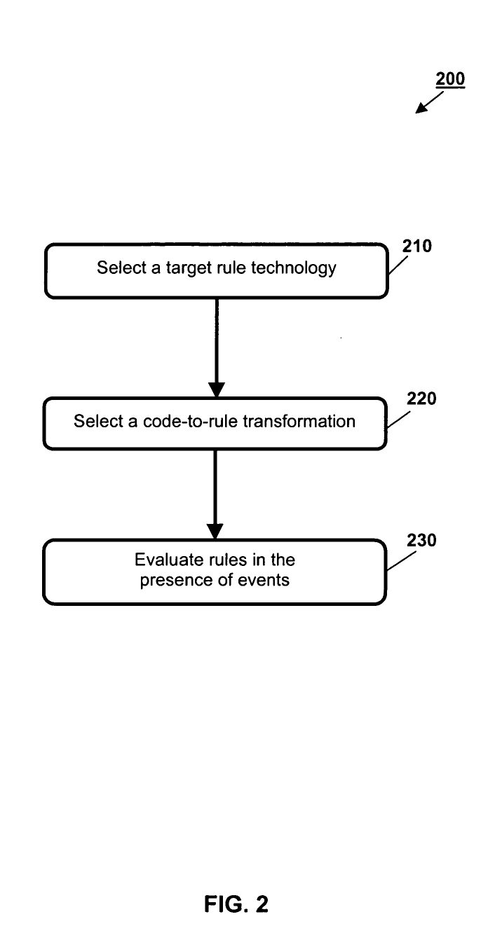

FIG. 2 presents a flow chart 200 of steps performed by the system architecture 100 of FIG. 1. A target rule technology is selected in step 210. A code-to-rule transformation is then selected in step 220. Finally, the transformed rules are evaluated in the presence of events in step 230. Various forms of implementation are possible for the system and procedure outlined in FIGS. 1 and 2, depending upon application requirements.

The code 130 is represented as a set of rules. Given the rules 140 and, optionally, an event trigger 120, such as a reported crime, the rules 140 are applied and evaluated assuming a particular user perspective 110. This user perspective 110 is represented as an evaluation function, which evaluates the target rules 140. The steps outlined in FIG. 2 are now described in further detail.

Selecting a Target Rule Technology—Step 210

At the outset, a decision is made on the representation of code using rules, namely what rules system is to be used. Examples of available choices for rules systems include fuzzy rules, if-then-else rules, and declarative rules, such as those used in the Prolog computer programming language.

A rules system can be selected based upon performance considerations. Rules systems can have particular usage requirements, such as acceptable response time, suitable levels of abstraction, performance of available computing hardware, and overall cost. Rules systems are studied as a discipline in the field of computer science, and the different forms of rules systems are characterized by their processing complexity. A rule can be considered to be a declarative statement in a formal notation.

Scripting rules include assertion (assignment) rules, if-then-else rules, for-loop rules, while-do, do-while, and do-until iteration rules, and can be processed using most programming languages. Inference rules include if-then rules, when-do pattern match rules, and predicate logic rules, which need an appropriate inference engine to process. While scripting rules can be processed a finite time, based on the size and nature of rules, inference on predicate logic rules can be undecidable. That is, the processing time may be unbounded. Accordingly, codes are desirably represented in an appropriate form, such that the rules are amenable to the kind of analysis that is to be performed.

Selecting a Code-to-Rule Transformation Technology—Step 220

Code 130 is mapped to a representation in the selected rules system in step 210. Mapping the code 130 to the target rules 140 need not be a literal or exact mapping, but can be any appropriate representation of the code 130. Elegant variations might be adopted for a number of reasons, depending upon the code 130, and the way in which its interpretation is likely to be conducted.

There are many alternatives to transform the code 130 into rules 140. Transformation can be manually performed by those who understand both the code 130 and the selected rules system. The logical structure of the code 130 is mapped, usually from a natural language such as the English language, to the target rules 140 system using the grammar and syntax of the selected rules system. The target rules 140 can be checked to ensure a lack of inconsistency with the code 130.

As an alternative to manually mapping the code 130 to target rules 140, suitable automated methods can be used for whole or part of this task. A template of target rules 140 may be generated automatically, and text or terms extracted from the code 130 used to populate the templates for a “first draft” of the target rules 140. As an example, consider two types of rules system templates in Table 1 below. The first type of rules system of Table 1 below is of the inference rule type, while the second type of rules system is of the scripting rule type.

TABLE 1

WHEN <pattern>
DO <action>
IF <antecedent condition>
THEN <consequent action>

Now consider an code in a corporate business policy: “When an employee wants to travel on business trip, the approvals other manager, second-line manager and finance is to be taken prior to any travel arrangements being made”.

Algorithms used in the field of Natural Language Understanding (NLU) can automatically extract phrases from text such as this provision of a corporate travel policy. Table 2 below presents a pseudocode algorithm that outlines how automatic mapping of code 130 to target rules 140 can be performed for the case of when-do rules. Essentially, parameters of the rules system templates of Table 1 above are extracted using the algorithm of Table 2 below, and these extracted components are used to populate the rules system templates.

TABLE 2
Algorithm: CodeToWhenDoRuleMapper (Code_text)

| | The text to be extracted is <pattern(s)> and <action(s)> |
|---|---|
| | Let Extracter1 = An NLU algorithm trained to extract |
| | <pattern(s)> |
| | Let Extracter2 = An NLU algorithm trained to extract |
| | <action(s)> |
| 1. | <pattern> = Extractor1(Code_text) |
| 2. | <action> = Extractor2(Code_text) |
| 3. | NewRule = Create and populate when-do rule instance with |
| | <pattern> and <action> |
| 4. | Return NewRule |

When CodeToWhenDoRuleMapper( ) algorithm in Table 2 above is invoked on the example policy text, the parameter <pattern> may be “business trip” and the parameter <action> may be “approval of manager; approval of second-line manager; approval of finance”. The returned rule is presented in Table 3 below.

TABLE 3

WHEN (“business trip”)
DO get-approval (“approval of manager”),

get-approval (“second-line manager”),
get-approval (“and finance”).

Evaluating Rules in the Presence of Events—Step 230

The target rules 140 can be analyzed using an appropriate rule evaluation function. The target rules 140 may be evaluated in response to a triggering event 120, and in view of a particular user perspective 110. Optionally, the information relating to an event (for example, a crime) may make some rather than all the rules applicable for analysis. The user perspective 110 reflects a particular user's interest in the code 130, with which the rule evaluation function is consistent.

Some examples of evaluation functions are presented in Table 4 below. Such evaluation functions may be used by various interested parties, such as teams prosecuting or defending a person alleged to have violated the code 130. Various other examples are possible, and vary according to the context of the code 130 under consideration, and its use.

TABLE 4

| | |
|---|---|
| Max Rᵢ | The number of applicable codes are maximum |
| Max PRᵢ | The punishment in the applicable codes are |
| | maximum |
| Min Rᵢ | The number of applicable codes are minimum |
| Min PRᵢ | The punishment in the applicable codes are |
| | minimum |
| For any event E, | The codes are defined for every crime |
| Rᵢ ∉ empty | |
| For any event E, | No crime goes unpunished |
| PRᵢ ≠ 0 | |

The result of using an evaluation function of the type tabulated in Table 4 above depends upon the target rules 140 that are used to represent the code 130, and the evaluation function that is used to evaluate the target rules 140.

Computer Hardware

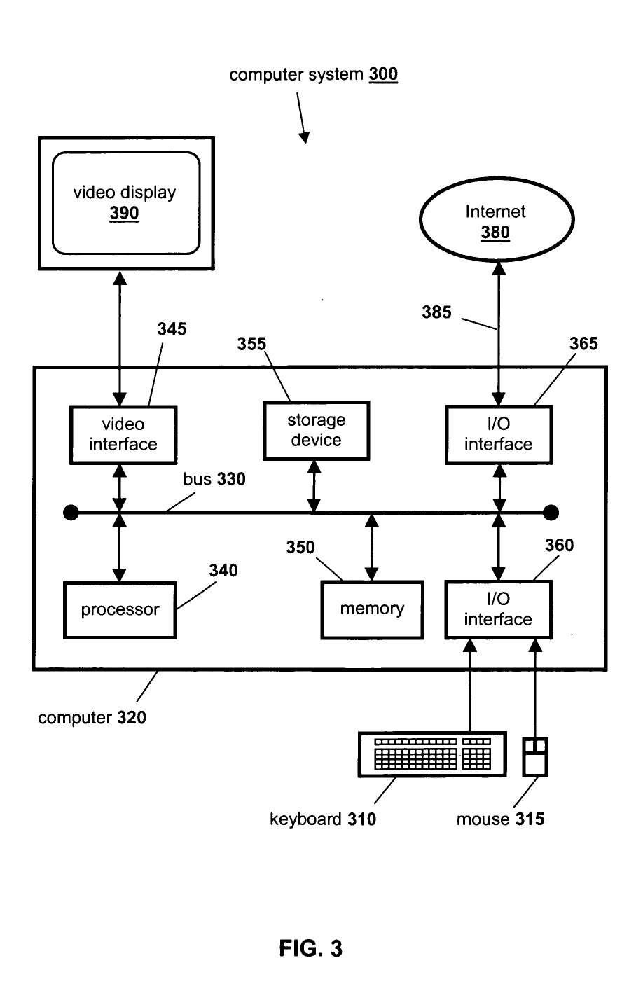

FIG. 3 is a schematic representation of a computer system 300 of a type that can be used, with suitable software, to interpret codes 130 as described herein. Computer software executes under a suitable operating system installed on the computer system 300 to assist in interpreting codes 130 as described. This computer software is programmed using any suitable computer programming language, and may be thought of as comprising various software code means for achieving particular steps.

The components of the computer system 300 include a computer 320, a keyboard 310 and mouse 315, and a video display 390. The computer 320 includes a processor 340, a memory 350, input/output (I/O) interfaces 360, 365, a video interface 345, and a storage device 355.

The processor 340 is a central processing unit (CPU) that executes the operating system and the computer software executing under the operating system. The memory 350 includes random access memory (RAM) and read-only memory (ROM), and is used under direction of the processor 340.

The video interface 345 is connected to video display 390 and provides video signals for display on the video display 390. User input to operate the computer 320 is provided from the keyboard 310 and mouse 315. The storage device 355 can include a disk drive or any other suitable storage medium.

Each of the components of the computer 320 is connected to an internal bus 330 that includes data, address, and control buses, to allow components of the computer 320 to communicate with each other via the bus 330.

The computer system 300 can be connected to one or more other similar computers via a input/output (I/O) interface 365 using a communication channel 385 to a network, represented as the Internet 380.

The computer software may be recorded on a portable storage medium, in which case, the computer software program is accessed by the computer system 300 from the storage device 355. Alternatively, the computer software can be accessed directly from the Internet 380 by the computer 320. In either case, a user can interact with the computer system 300 using the keyboard 310 and mouse 315 to operate the programmed computer software executing on the computer 320.

Other configurations or types of computer systems can be equally well used to interpret legal codes as described. The computer system 300 described above is described only as an example of a particular type of system suitable for implementing the described techniques. As an example, suitable software may instead be implemented using a personal digital assistant (PDA) or other similar computing device.

Computer Software

As described, the same code is interpreted for different users, and one can thus expect that such users may prefer to use different types of devices. Software that executes on particular hardware may be subject to hardware-related restrictions that can limit the software features that are available using that hardware. As an example, personal digit assistants (PDAs) have memory ranging in capacity from hundreds of kilobytes to a few Megabytes. Desktop personal computers have memories ranging in capacity from hundreds of Megabytes to a few Gigabytes, while high-performance servers can have a memory capacity in the range of hundreds of Gigabytes.

Since code 130 represented as rules 140 is loaded into memory for interpretation, not all hardware can process with the same set of rules 140. Either the number of rules can be reduced for smaller devices, or the level of detail reduced. The former is not an option as the soundness of interpretation may be affected. Accordingly, more complex rules 140 may be limited to correspondingly sophisticated computing hardware.

Example—Indian Penal Code

As a particular example, consider the Indian Penal Code system (IPC) as a code 130. Sections 299 to 309 of the IPC apply to the suspicious death of a person. Possible reasons range from suspected homicide, murder, suicide, etc, as indicated in Table 5 below.

TABLE 5

| | |
|---|---|
| 299. | Culpable homicide |
| 300. | Murder |
| 301. | Culpable homicide by causing death of person other than |
| | person whose death was intended |
| 302. | Punishment for murder |
| 303. | Punishment for murder by life-convict |
| 304. | Punishment for culpable homicide not amounting to murder |
| | 304A. Causing death by negligence |
| | 304B. Dowry death |
| 305. | Abetment of suicide of child or insane person |
| 306. | Abetment of suicide |
| 307. | Attempt to murder |
| 308. | Attempt to commit culpable homicide |
| 309. | Attempt to commit suicide |

Stage 1: Identify Code

This example concerns only a particular aspect of the IPC, namely those sections of the IPC relating to death. The relevant sections are a subset of those presented in Table 5 above, namely Sections 299 to 304. These Sections are provided in Table 6 below.

TABLE 6

| 299. | | Culpable homicide |
|---|---|---|
| | | Whoever causes death by doing an act with the intention |
| | | of causing death, or with the intention of causing such |
| | | bodily injury as is likely to cause death, or with the |
| | | knowledge that he is likely by such act to cause death, |
| | | commits the offence of culpable homicide. |
| 300. | | Murder |
| | | Except in the cases hereinafter excepted, culpable homi- |
| | | cide is murder, if the act by which the death is caused |
| | | is done with the intention of causing death, or |
| | | Secondly, if it is done with the intention of causing |
| | | such bodily injury as the offender knows to be likely |
| | | to cause the death of the person to whom the harm is |
| | | caused, or |
| | | Thirdly, if it is done with the intention of causing |
| | | bodily injury to any person and the bodily injury |
| | | intended to be inflicted is sufficient in the ordinary |
| | | course of nature to cause death, or |
| | | Fourthly, if the person committing the act knows that it |
| | | is so imminently dangerous that it must, in all proba- |
| | | bility, cause death or such bodily injury as is likely |
| | | to cause death, and commits such act without any excuse |
| | | for incurring the risk of causing death or such injury |
| | | as aforesaid. |
| 301. | | Culpable homicide by causing death of person other than |
| | | person whose death was intended |
| | | If a person, by doing anything which he intends or knows |
| | | to be likely to cause death, commits culpable homicide |
| | | by causing the death of any person, whose death he |
| | | neither intends nor knows himself to be likely to cause, |
| | | the culpable homicide committed by the offender is of |
| | | the description of which it would have been if he had |
| | | caused the death of the person whose death he intended |
| | | or knew himself to be likely to cause. |
| 302. | | Punishment for murder |
| | | Whoever commits murder shall be punished with death, or |
| | | imprisonment for life, and shall also be liable to fine. |
| 303. | | Punishment for murder by life-convict |
| | | Whoever, being under sentence of imprisonment for life, |
| | | commits murder, shall be punished with death. |
| 304. | | Punishment for culpable homicide not amounting to murder |
| | | Whoever commits culpable homicide not amounting to |
| | | murder shall be punished with imprisonment for life, or |
| | | imprisonment of either description for a term which may |
| | | extend to ten years, and shall also be liable to fine, |
| | | if the act by which the death is caused is done with the |
| | | intention of causing death, or of causing such bodily |
| | | injury as is likely to cause death, |
| | | or with imprisonment of either description for a term |
| | | which may extend to ten years, or with fine, or with |
| | | both, if the act is done with the knowledge that it is |
| | | likely to cause death, but without any intention to |
| | | cause death, or to cause such bodily injury as is likely |
| | | to cause death. |
| 304A. | | Causing death by negligence |
| | | Whoever causes the death of any person by doing any rash |
| | | or negligent act not amounting to culpable homicide, |
| | | shall be punished with imprisonment of either descrip- |
| | | tion for a term which may extend to two years, or with |
| | | fine, or with both. |
| 304B. | | Dowry death |
| | (1) | Where the death of a woman is caused by any burns or |
| | | bodily injury or occurs otherwise than under normal |
| | | circumstances within seven years of her marriage and it |
| | | is shown that soon before her death she was subjected |
| | | to cruelty or harassment by her husband or any relative |
| | | of her husband for, or in connection with, any demand |
| | | for dowry, such death shall be called “dowry death”, and |
| | | such husband or relative shall be deemed to have caused |
| | | her death. |
| | Explanation: For the purpose of this sub-section, | |
| | “dowry” shall have the same meaning, as in Section 2 of | |
| | the Dowry Prohibition Act, 1961 (28 of 1961). | |
| | (2) | Whoever commits dowry death shall be punished with |
| | | imprisonment for a term which shall not be less than |
| | | seven years but which may extend to imprisonment for |
| | | life. |

Stage 2: Identify Target Rules

The use “if-then” rules is assumed in this case. Tables 7, 8 and 9 below present, as examples, target rules 140 for respective Sections 299, 300 and 301 of the IPC. Table 7 below presents target rules 140 for Section 299 of the IPC dealing with “Culpable homicide”.

TABLE 7

IF

Event = = death and
Intention = = cause_death

THEN

Offence = culpable_homicide and
IPC_applied.update(299)

The target rules 140 of Table 7 has the statement IPC_appliedupdate(299). “IPC_applied” is a set referring to the set of IPC provisions that are applicable. The update( ) function adds a new element to this set. Hence, in this example, IPC_applied={299}. A corresponding statement is IPC_applied=IPC_applied ∪ {299}, in which ∪ is the union set operator.

Section 299 of the IPC permits “intention to be enough harm that it causes death”. This provision is complex to represent in the “if-then” rules system and, incidentally, is difficult to determine from a preliminary investigation of a suspected violation of this Section. Hence, the target rules 140 may disregard this aspect of the code 130 without detrimental effect to the practical use of interpreting the code 130.

Table 8 below presents target rules 140 for Section 300 of the IPC dealing with “Murder”.

TABLE 8

IF

Offence = = culpable_homicide and

IPC_applied not in [301 to 309]

THEN

Offence = murder and

IPC_applied.update(300)

Table 9 below presents part of the target rules 140 for Section 301 of the IPC dealing with “Culpable homicide by causing death of person other than person whose death was intended”.

TABLE 9

IF

Offence = = culpable_homicide and

intended_person = dead_person

THEN

Offence = culpable_homicide and
IPC_applied.update(301)

...

Stage 3 and 4: Evaluate Rules

Suppose the event is the death of a male person and there is a repentant accused present. A first case recording the crime, which requires a detailed analysis of all relevant legal provisions. Accordingly, an evaluation function of “Max Rᵢ” can be used, which implies that no IPC provision should be missed.

Table 10 below presents a pseudocode function of how evaluation is performed. The RULE_list for this example is the set of IPCs represented as rules.

TABLE 10

Function Evaluate(RULE_list, EvalFunction, event) {

1. Result = { }
2. For each RULE_item in RULE_list
3. If(EvalFunction(RULE_item, event) == Success) {

a. Result = Result U RULE_item

}

}
Max Rᵢ( ), the evaluation function in the example, can be
implemented as follows:
Function Max Rᵢ(Rule_item){

1. If Rule_item relates to event

a. Return SUCCESS

2. Else

a. Return FAILURE

}

From the set of IPC presented in Table 6 above (Sections 299 to 304), Sections 299 and 300 are returned as applicable when the target rules 140 are evaluated using this rule evaluation function. Section 301 is not applicable, as the accused is claiming that he perpetrated the crime. Section 302 is applicable as the possible section for punishment. Section 303 is not applicable the accused is not a life-convict, as the accused is not in jail. Section 304 is not applicable as the accused is not involved in a road driving case or dowry case.

A second case is defence of the accused, which concerns minimizing punishment of the accused. Accordingly, the evaluation function adopted in this case might be “Min PRᵢ”, which reflects this objective of minimizing punishment of the accused.

From the set of IPC presented (Sections 299 to 304), the Section 304A has the minimum punishment. Therefore, the defense may want to downgrade the event as a traffic accident or careless driving.

Example—Corporate Travel Policy

Stage 1: Identify Code

The code 130 is this example is a corporate travel policy concerning how business travel is to be conducted. Table 11 below outlines Articles of this travel policy.

TABLE 11

| | |
|---|---|
| 1. | Planned Business Travel |
| | The trip is planned not less than 2 weeks in advance from the |
| | date of commencement. The approval of the immediate manager |
| | is required. Economy class travel using company approved |
| | transport and hotel vendors must be used for making |
| | reservations. |
| 2. | Immediate Business Travel |
| | The trip is planned not less than 2 days in advance from the |
| | date of commencement. The approval of the second-line manager |
| | is required. Company approved hotel vendors must be used for |
| | making reservations and a justification for the immediateness |
| | of the travel has to be submitted. |
| 3. | Urgent Business Travel |
| | The trip needs to start immediately. The approval of the CFO |
| | is needed and a justification for the urgency of the travel |
| | from the employee's manager has to be submitted. |

Stage 2: Identify Target Rules

As with the former rules, the use of if-then rules is assumed. Tables 12, 13 and 14 present target rules 140 for respective Articles of the travel policy. Table 12 below presents target rules 140 for Article 1 of the travel policy entitled “Planned Business Travel”.

TABLE 12

IF

Travel_notice >= 2_weeks and
Approval = 1st_manager

THEN

Travel_type = planned and
Travel_vendor = company_approved and
Hotel_vendor = company_approved

Table 13 below presents target rules 140 for Article 2 of the travel policy entitled “Immediate Business Travel”.

TABLE 13

IF

Travel_notice >= 2_days and < 2_weeks and
Justification = true and
Approval = 2nd_manager

THEN

Travel_type = immediate and
Hotel_vendor = company_approved

Table 14 below presents target rules 140 for Article 3 of the travel policy entitled “Urgent Business Travel”.

TABLE 14

IF

Travel_notice < 1_day and
Justification = true and
Approval = CFO

THEN

Travel_type = urgent

Stage 3 and 4: Evaluate Rules

The example may be one in which an employee is asked to travel for business, and needs to know which of the relevant provisions of the travel policy are applicable. This example thus may have an evaluation rule of “Find Rᵢ”. This evaluation rule finds the relevant Articles of the travel policy. Another evaluation function can be Find Rᵢ (Min Company_Approved_Vendor), which finds Articles with maximum freedom concerning which vendor can be selected. The mechanics of this operation are similar to that described in the above example in relation to the IPC, and are accordingly not repeated for this example.

The evaluation function and the event are used to determine the resulting rule list. From the three Articles, the Article which results from the evaluation function is “Immediate Business Travel”, which indicates that the employee should seek approval from his second line manager. This Article also indicates that the employee should also use a company approved hotel, but can book on any flight.

Another example is that of a team evaluating corporate travel policies. The team wants to know which employee groups are not covered by the travel policy. The evaluation function that can be used in this case is “Find Empᵢ (Find Rᵢ=0). This evaluation rule finds employees for whom no travel policy rule is currently specified.

As a result of this evaluation, one can determine that, assuming that there are employees above the Chief Financial Officer (CFO) of the company (for example, Chief Executive Officer (CEO)), all employees with grade above CFO cannot make urgent business travel because those employees cannot seek approval from a lower ranked officer. Hence, the Urgent Travel rule may be modified accordingly to clarify any ambiguity or address any limitation of the travel policy.

Conclusion

Various alterations and modifications can be made to the techniques and arrangements described herein, as would be apparent to one skilled in the relevant art.

1. A method for interpreting codified provisions said method comprising the steps of:
storing codified provisions concerning events as rules that use logical expressions to represent a logical structure of the codified provisions;
storing evaluation functions as logical conditions relating to the stored rules; and
evaluating the rules using at least one of the stored evaluation functions for an event concerning the codified provisions.

2. The method as claimed in claim 1, further comprising the step of mapping the codified provisions to rules.

3. The method as claimed in claim 1, further comprising the step of restricting the rules that are evaluated using the evaluation functions.

4. The method as claimed in claim 1, further comprising the steps of extracting rules system parameters from text of the codified provisions; and populating rules system templates using the extracted rules system parameters.

5. The method as claimed in claim 1, wherein the rules are expressed in a scripting rules system.

6. The method as claimed in claim 1, wherein the rules are expressed in the if-then-else rules system.

7. The method as claimed in claim 1, wherein the codified provisions relate to a legal code.

8. A computer system for interpreting codified provisions comprising:
computer software code means for storing codified provisions concerning events as rules that use logical expressions to represent a logical structure of the codified provisions;
computer software code means for storing evaluation functions as logical conditions relating to the stored rules; and
computer software code means for evaluating the rules using at least one of the stored evaluation functions for an event concerning the codified provisions.

9. A computer program product for interpreting codified provisions comprising computer software recorded on a medium for performing the steps of:
storing codified provisions concerning events as rules that use logical expressions to represent a logical structure of the codified provisions;
storing evaluation functions as logical conditions relating to the stored rules; and
evaluating the rules using at least one of the stored evaluation functions for an event concerning the codified provisions.

10. The A computer program product as claimed in claim 9, further comprising the step of mapping the codified provisions to rules.

11. The A computer program product as claimed in claim 9, further comprising the step of restricting the rules that are evaluated using the evaluation functions.

12. The computer program product as claimed in claim 9, further comprising the steps of extracting rules system parameters from text of the codified provisions; and populating rules system templates using the extracted rules system parameters.

13. The computer program product as claimed in claim 9, wherein the rules are expressed in a scripting rules system.

14. The computer program product as claimed in claim 9, wherein the rules are expressed in the if-then-else rules system.

15. The computer program product as claimed in claim 9, wherein the codified provisions relate to a legal code.
